(19) United States
(12) Patent Application Publication
(10) Pub. No.: US 2025/0012941 A1
(43) Pub. Date: Jan. 9, 2025

(54) APPARATUS AND METHOD FOR REVERSE-TIME MIGRATION OF VERTICAL CABLE SEISMIC SURVEY DATA USING DIRECTIONAL PROPAGATION OF RECEIVER WAVEFIELDS

(71) Applicant: KOREA INSTITUTE OF OCEAN SCIENCE & TECHNOLOGY, Busan (KR)

(72) Inventors: Jong Ha HWANG, Busan (KR); Sang Hoon LEE, Busan (KR); Yun Hui PARK, Busan (KR); Soo Kwan KIM, Busan (KR); Su Hwan LEE, Busan (KR); Hye Jin MOON, Busan (KR)

(73) Assignee: KOREA INSTITUTE OF OCEAN SCIENCE & TECHNOLOGY, Busan (KR)

(21) Appl. No.: 18/750,554

(22) Filed: Jun. 21, 2024

(30) Foreign Application Priority Data
Jul. 4, 2023 (KR) 10-2023-0086458

(51) Int. Cl. G01V 1/34; G01V 1/38

(52) U.S. Cl. CPC G01V 1/345; G01V 1/3852

(57) ABSTRACT

The present disclosure relates to a reverse-time migration method for marine vertical cable seismic (VCS) survey data and provides a reverse-time migration apparatus and method for vertical cable seismic (VCS) survey data using directional propagation of receiver wavefields, configured to perform equation-of-motion-based transform and inverse-transform processing on observed pressure wavefields during back-propagation of receiver wavefields to solve the problem of reflection boundary screening due to long-wavelength artifacts and avoid up/down wavefield separation to thereby simplify a migration process and improve overall quality of migration images.

### CROSS-REFERENCE TO RELATED APPLICATIONS

This application claims priority to Korean Patent Application No. 10-2023-0086458 filed on Jul. 4, 2023, the entire contents of which are herein incorporated by reference.

### TECHNICAL FIELD

The present disclosure relates to a method for reverse-time migration of marine vertical cable seismic (VCS) survey data, and more particularly, to an apparatus and method for reverse-time migration of vertical cable seismic (VCS) survey data using directional propagation of receiver wavefields, configured to perform equation-of-motion-based transform and inverse-transform processing on observed pressure wavefields during back-propagation of receiver wavefields to solve the problem of reflection boundary screening due to long-wavelength artifacts and avoid up/down wavefield separation to thereby simplify a migration process and improve overall quality of migration images.

### BACKGROUND

In general, a marine vertical cable seismic (VCS) survey is a survey method in which hydrophones are arranged vertically into the seawater and acoustic sources are shot from the sea surface to obtain seismic data, and has the advantages of lower risk of equipment loss due to fishing vessels or fishing nets, and flexible survey design in marine environments with many vessels or marine structures (platforms, offshore wind farms, and fishing nets) compared to a streamer survey.

In addition, the VCS survey is expected to provide a higher signal-to-noise ratio than the streamer survey because the data is observed in a relatively quiet deep seawater environment compared to the sea surface, and obtain relatively precise migration images because dense ray paths in a limited narrow area are obtained when the same number of sources are used.

In addition, the vertical array of hydrophones in the VCS survey enables up/down wavefield separation of upgoing primary reflections and downgoing receiver ghosts which are reflected downward after hitting the sea surface.

However, since the reflection signals of the VCS survey data do not usually share a common midpoint, it is difficult to apply seismic data processing techniques based on the common midpoint assumption, and therefore, it is common to apply two-way wave equation-based imaging techniques to VCS survey data, such as reverse-time migration.

In this case, reverse-time migration is a method that obtains source wavefields and receiver wavefields at each time step and nodal point through wavefield propagation modeling based on the two-way wave equation, respectively, and generates migration images with strong image values at the reflection boundaries by combining the wavefields into imaging conditions.

In addition, reverse-time migration is a migration method that is still being utilized and developed to this day despite the large amount of computation due to the advantages that it can derive accurate underground images even in complex underground structures and it has no limitations on the applications regardless of the locations or arrangements of source-receiver pairs.

In other words, various techniques regarding methods for reverse-time migration for imaging seismic survey data have been proposed, including, for example, “Seismic imaging system using reverse-time migration algorithm” of Korean Patent Registration No. 10-1413751 and “Apparatus and method for reverse-time migration capable of gathering frequency-domain common image points” of Korean Patent Registration No. 10-2026064.

However, these conventional reverse-time migration techniques are designed for application to surface seismic survey data, such as, for example, streamer survey or ocean-bottom survey, and it is difficult to produce high-quality migration images even if the conventional reverse-time migration techniques are applied to VCS survey data.

More specifically, when conventional reverse-time migration techniques are directly applied to VCS survey data, unlike the streamer survey, due to the characteristics of the VCS survey where the receivers are located at a considerable depth from the sea surface, the reflection signals with large reflection angles dominate in the recorded signals, as a result, since strong long-wavelength components appearing in the migration images screen short-wavelength components suitable for representing the reflection boundaries, the problem of the reflection boundary screening due to long-wavelength artifacts appears strongly in the produced migration images.

To avoid this problem, conventional methods, for example, Jamali et al. (2019) and Wang et al. (2022), applied up/down wavefield separation to the observed pressure wavefield obtained from a VCS survey to extract only receiver ghosts guaranteeing relatively narrow reflection angles and utilized them for reverse-time migration (see Non-Patent Document 1 and Non-Patent Document 2).

However, in the above-mentioned method, even information useful for constructing the reflection boundary such as primary reflection signals with narrow reflection angles are removed, resulting in weak image values at the location of the reflector, and accordingly, image noise becoming prominent, and a decrease in the overall migration image quality.

Any of the methods proposed so far regarding the above-mentioned up/down wavefield separation cannot completely separate wavefields, and in the case of the median filter, which is most popularly utilized for up/down wavefield separation, a wavefield flattening process through the reflection arrival time picking must be preceded, and therefore, an additional image noise due to up/down wavefield separation is generated in the conventional migration images, and the migration process is complicated.

Therefore, to solve the above-mentioned problems of the conventional reverse-time migration method of VCS survey data, it is desirable to propose a novel reverse-time migration method of marine vertical cable seismic (VCS) survey data configured to solve the problem of reflection boundary screening due to long-wavelength artifacts of reverse-time migration images without an up/down wavefield separation process to further improve the quality of generated migration images; however, no apparatus or method that satisfies all such needs has been proposed so far.

### PRIOR ART LITERATURE

### Patent Documents

(Patent Document 001): Korean Patent Registration No. 10-1413751 (Jul. 1, 2014)
(Patent Document 002): Korean Patent Registration No. 10-2026064 (Sep. 27, 2019)

### Non-Patent Documents

(Non-Patent Document 001): Jamali, H. E., Katou, M., Tara, K., Asakawa, E., and Mikada, H., 2019, “Mirror reverse time migration using vertical cable seismic data for methane hydrate survey”, Geophysics, 84 (6), B447-B460.
(Non-Patent Document 002): Wang, L., Wang, Z., Liu, H., Zhang, J., Xing, L., and Yin, Y., 2022, “Hydrate-bearing sediment imaging of ghost reflection in vertical cable seismic data using seismic interferometry”, Geofluids, 2022, 3501755.

### SUMMARY

The present disclosure has been made to solve the above-mentioned problems of the conventional methods for reverse-time migration of VCS survey data, and therefore, an object of the present disclosure is to propose an apparatus and method for reverse-time migration of vertical cable seismic (VCS) survey data using directional propagation of receiver wavefields configured to solve the problem of reflection boundary screening due to long-wavelength artifacts without up/down wavefield separation by utilizing observed pressure wavefields having undergone equation of motion-based transform and inverse-transform processing as virtual sources during back-propagation of receiver wavefields to thereby improve the quality of migration images and simplifying the migration processing.

In order to achieve the object, the present disclosure provides a reverse-time migration method for vertical cable seismic (VCS) survey data using directional propagation of receiver wavefields, the method including a data gathering step in which a process of gathering vertical cable seismic (VCS) survey data is performed; and a reverse-time migration processing step in which a process of performing reverse-time migration based on directional propagation of receiver wavefields on the VCS survey data gathered through the data gathering step to generate migration images is performed, wherein the method is configured to solve a problem of reflection boundary screening by long-wavelength artifacts to thereby improve quality of the migration images generated through the reverse-time migration and simplify an overall migration process.

Here, the method may further include an image output step in which a process of outputting the migration images generated through the reverse-time migration processing step via a monitor or a display is performed; and a database construction step in which a process of constructing a database by storing various pieces of data obtained through the processes and processing results of the data gathering step and the reverse-time migration processing step in a separate database or transmitting the data to an external device according to a predetermined setting is performed.

The data gathering step may be configured so that a process of receiving real-time survey data from a vertical cable seismic (VCS) survey means installed in a survey area or receiving input of survey data gathered in advance from an external source is performed.

The reverse-time migration processing step may include: a pre-processing step in which a process of performing pre-processing on observed VCS pressure wavefield data according to a predetermined setting and determining a velocity model is performed; a reverse-time reconstruction processing step in which a process of modeling source wavefield propagation, storing boundary values at all time steps, and performing reverse-time reconstruction of source wavefields is performed; a transform and inverse-transform processing step in which a process of transforming the observed pressure wavefield data into particle acceleration wavefield data and performing inverse-transform is performed; a back-propagation modeling processing step in which a process of performing back-propagation modeling of receiver wavefields using the observed pressure wavefield data having undergone the transform and inverse-transform processing as virtual sources is performed; and an image generation step in which a process of substituting processing results from the reverse-time reconstruction processing step and the back-propagation modeling processing step into a predetermined inverse scattering imaging condition to calculate image values for each time step and all source-receiver pairs is performed.

The transform and inverse-transform processing step may be configured so that a transform process of transforming the observed pressure wavefield data into particle acceleration wavefield data is performed by calculating a particle acceleration wavefield for each direction through a spatial finite difference of pressure wavefields based on a relational expression between a pressure wavefield and a particle acceleration wavefield, and the relational expression may be represented by the following equation:

a(x,y,z,t)=∇p(x,y,z,t)

(Where p is a pressure wavefield at a certain position expressed by (x, y, z) and time t, a=(αx, αy, αz) is a component vector of a particle acceleration wavefield, and ∇ is a spatial gradient.)

The transform and inverse-transform processing step may be configured so that, based on a fact that, when a transform process of transforming the observed pressure wavefield data into particle acceleration wavefield data is expressed by a linear operator Q, the inverse-transform process of inverse-transforming the transformed particle acceleration wavefields back to pressure wavefields is defined as a transpose Q^{T} of the linear operator Q, the transform process and the inverse-transform process are sequentially performed using the following equation:

p′=Q^{T}Qp

(Where p is a vector composed of the pressure wavefield data observed at a location of a group of receivers, and p′ is a vector composed of pressure wavefield data calculated at the same location through the transform and inverse-transform processes.)

The reverse-time migration processing step may be configured so that the reverse-time reconstruction processing step, the transform and inverse-transform processing step, and the back-propagation modeling processing step are processed in parallel for each source using multi-processors, whereby an overall processing time is reduced.

The image generation step may be configured so that a process of generating reverse-time migration images using an inverse scattering imaging condition (ISIC) expressed by the following equation is performed.

$${I}_{ISIC} ( x , y , z ) = \frac{\begin{matrix}{\sum }_{s} {\sum }_{r} {\int }_{0}^{T} \frac{1}{{v}_{p}^{2} ( x , y , z )} \frac{\partial {p}_{s} ( x , y , z , t )}{\partial t} \times \frac{\partial {p}_{r} ( x , y , z , T - t )}{\partial t} + \\ ∇ {p}_{s} ( x , y , z , t ) \cdot ∇ {p}_{r} ( x , y , z , T - t ) dt\end{matrix}}{{\sum }_{s} {\int }_{0}^{T} {p}_{s}^{2} ( x , y , z , t ) dt}$$

(Where I_{ISIC} is a migration image value under the inverse scattering imaging condition, Σs and Σr are summation processes for all sources and all receivers, respectively, T is a total recording time, pₛ is a source wavefield obtained by forward propagation at a source location, pᵣ is a receiver wavefield obtained by back-propagating a virtual source at a receiver location, vₚ is a P-wave velocity at each (x, y, z) location, and ∇ is a spatial gradient.)

The present disclosure also provides a reverse-time migration apparatus for vertical cable seismic (VCS) survey data, the apparatus including a data gathering unit configured to perform a process of gathering vertical cable seismic (VCS) survey data; a reverse-time migration processing unit configured to perform a process of performing reverse-time migration on the VCS survey data gathered by the data survey unit; an output unit configured to perform a process of outputting various pieces of data including data gathered by the data gathering unit, processing results from the reverse-time migration processing unit, and information on a current state and an operation of the reverse-time migration apparatus; a communication unit configured to perform a process of transmitting and receiving various pieces of data by communicating with an external device including a server in at least one of wired or wireless communication according to a predetermined setting; and a control unit configured to perform a process of controlling an overall operation of the reverse-time migration apparatus, wherein the reverse-time migration processing unit is configured to perform a reverse-time migration process using the above-mentioned reverse-time migration method for vertical cable seismic (VCS) survey data using directional propagation of receiver wavefields.

Here, the data gathering unit may be configured to perform a process of receiving real-time survey data from a separate vertical cable seismic (VCS) survey means or receiving input of survey data gathered in advance.

The output unit may be configured to include a monitor or a display for visually displaying the various pieces of data including the data gathered by the data gathering unit, the processing results from the reverse-time migration processing unit, and the information on the current state and the operation of the reverse-time migration apparatus according to a predetermined setting.

The reverse-time migration apparatus may further include a database unit for storing various pieces of data obtained through the processing of the data gathering unit and the reverse-time migration processing unit, and the control unit may be configured to perform, based on the data stored in the database unit, a process of providing various pieces of information obtained through a vertical cable seismic (VCS) survey according to a request of a user in conjunction with an external device including a user terminal and a server in a customized manner.

The present disclosure also provides a vertical cable seismic (VCS) imaging system, including: a plurality of VCS survey units configured to perform a process of gathering vertical cable seismic (VCS) survey data for each area and performing reverse-time migration to generate VCS migration images; a server configured to perform a process of storing survey information gathered by the VCS survey units and the migration images for each area in a database and providing a corresponding service according to a request of a user; and a user terminal for requesting and receiving a service desired by each user in connection with the VCS survey units and the server, wherein the VCS survey unit is configured to perform a process of performing a reverse-time migration process on the VCS survey data using the above-mentioned reverse-time migration method for vertical cable seismic (VCS) survey data using directional propagation of receiver wavefields and transmitting the gathered survey data and the processed data to the server.

Here, the user terminal may be configured by installing a dedicated application interfacing with the VCS survey units and the server on a personal portable telecommunication terminal including a smartphone and a tablet PC, or an information processing device including a PC and a laptop.

According to the present disclosure, it is possible to perform directional propagation of receiver wavefields by transforming observed pressure wavefields into particle acceleration wavefields based on the Newton's equation of motion and inverse-transforming it into a form of pressure wavefield data, utilizing it as virtual sources. In addition, when it is applied to reverse-time migration of vertical cable seismic (VCS) survey data, due to the vertical receiver array of the VCS survey, the influence of the wavefields along the vertical ray path is enhanced and the influence of the wavefields along the horizontal ray path is weakened. In this way, it is possible to solve the problem of reflection boundary screening due to strong long-wavelength artifacts, which is the problem in the conventional technique.

According to the present disclosure, it is possible to improve the quality of migration images generated through reverse-time migration of VCS survey data and simplify the migration process by preventing the utilization of primary reflection signals with narrow reflection angles and avoiding the up/down wavefield separation process that causes additional image noise.

### BRIEF DESCRIPTION OF THE DRAWINGS

FIG. 1 is a flowchart schematically illustrating the overall configuration of a conventional reverse-time migration method;

FIG. 2 is a diagram illustrating isotropic propagation of receiver wavefields when twenty-five receivers are arranged in a grid and the observed pressure wavefield data is utilized directly as virtual sources;

FIG. 3 is a diagram illustrating directional propagation of receiver wavefields when twenty-five receivers are arranged in a grid and pressure wavefield data having undergone transform and inverse-transform according to the embodiment of the present disclosure is utilized as virtual sources;

FIG. 4 is a flowchart schematically illustrating the overall configuration of a reverse-time migration method for vertical cable seismic (VCS) survey data utilizing directional propagation of receiver wavefields according to an embodiment of the present disclosure;

FIG. 5 is a flowchart schematically illustrating the overall processing of a reverse-time migration processing step in the reverse-time migration method for vertical cable seismic (VCS) survey data using directional propagation of receiver wavefields according to the embodiment of the present disclosure shown in FIG. 4;

FIG. 6 is a diagram showing a comparison of migration images generated by applying conventional VCS survey data reverse-time migration techniques and migration images generated by applying the technique of the present disclosure to verify the actual performance of the reverse-time migration method for vertical cable seismic (VCS) survey data using directional propagation of receiver wavefields according to the embodiment of the present disclosure;

FIG. 7 is a block diagram schematically illustrating the overall configuration of a reverse-time migration apparatus of VCS survey data using the reverse-time migration method for vertical cable seismic (VCS) survey data using directional propagation of receiver wavefields according to the embodiment of the present disclosure; and

FIG. 8 is a block diagram schematically illustrating the overall configuration of a vertical cable seismic (VCS) imaging system according to an embodiment of the present disclosure.

### DETAILED DESCRIPTION OF THE PREFERRED EMBODIMENTS

Hereinafter, a specific embodiment of a reverse-time migration method for vertical cable seismic (VCS) survey data using directional propagation of receiver wavefields according to the present disclosure will be described with reference to the accompanying drawings.

It should be noted that the following description is merely one embodiment for implementing the present disclosure, and the present disclosure is not limited to the contents of the embodiment described below.

It should also be noted that, in the following description of embodiments of the present disclosure, the detailed description of parts which are the same or similar to those of the prior art or which can be easily understood and practiced by those skilled in the art will be omitted for the sake of simplicity of description.

Next, with reference to the drawings, specific details of a reverse-time migration method for vertical cable seismic (VCS) survey data using directional propagation of receiver wavefields according to the present disclosure will be described.

First, to describe a vertical cable seismic (VCS) survey, unlike a streamer survey method in which long streamers composed of a horizontal array of hydrophones and sources are towed simultaneously by a survey vessel to acquire data, the VCS survey is a survey method in which a vertical array of hydrophones is deployed near the relatively deep and quiet seafloor and only sources are towed by a survey vessel to acquire data, and has the advantage of reducing the risk of survey in nearshore areas where there are many human activities (fishing and cargo shipping) and offshore facilities such as offshore platforms and offshore wind farms since it does not require the towing of long streamers and the advantages of being able to acquire high-quality signals due to low background noise in the seawater where hydrophones are located and enabling up/down wavefield separation due to the vertical receiver array.

However, since the vertical cable seismic (VCS) survey has an antisymmetric survey geometry due to the relatively large depth difference between the source and receiver, it is difficult to apply data processing techniques based on the common-midpoint assumption utilized in streamer survey data processing, and as a result, a reverse-time migration method that does not restrict the application of the technique depending on the source-receiver arrangement is generally applied to VCS survey data imaging.

The reverse-time migration method is a technique that can generate images of underground reflection boundaries by applying specified imaging conditions to the acquired data, and since this method most accurately simulates wavefield propagation by utilizing a two-way wave equation, it has the advantage of enabling accurate imaging even in complex underground structures, unlike other migration techniques (frequency-domain migration, finite-difference migration, and Kirchhoff migration).

In addition, the most frequently utilized imaging condition of reverse-time migration is the zero-delay cross-correlation imaging condition, which can be expressed as Equation 1 below.

$$I ( x , y , z ) = \frac{{\sum }_{s} {\sum }_{r} {\int }_{0}^{T} {p}_{s} ( x , y , z , t ) \times {p}_{r} ( x , y , z , T - t ) dt}{{\sum }_{s} {\int }_{0}^{T} {p}_{s}^{2} ( x , y , z , t ) dt} \qquad [ Equation l ]$$

Here, in Equation 1, I is a reverse-time migration image value, Σs and Σr are the summation processes for all sources and all receivers, respectively, T is the total recording time, pₛ is the source wavefield obtained by forward propagation at the source location, and pᵣ is the receiver wavefield obtained by back-propagating a virtual source at the receiver location.

Therefore, according to Equation 1, the reverse-time migration image is obtained by multiplying and adding the source wavefield and receiver wavefield for each time step from 0 seconds to the total recording time T seconds for each (x, y, z) location, summing the addition results for all source-receiver pairs used in the survey, and normalizing the summation result to the square sum of source wavefields.

However, when the reverse-time migration is performed based on Equation 1, the quality of the images generated by the migration is degraded due to the backscattered cross-correlation noise, and therefore, an inverse scattering imaging condition (ISIC) has been proposed as shown in Equation 2 below so that the backscattered cross-correlation noise can be significantly suppressed.

$${I}_{ISIC} ( x , y , z ) = \frac{\begin{matrix}{\sum }_{s} {\sum }_{r} {\int }_{0}^{T} \frac{1}{{v}_{p}^{2} ( x , y , z )} \frac{\partial {p}_{s} ( x , y , z , t )}{\partial t} \times \frac{\partial {p}_{r} ( x , y , z , T - t )}{\partial t} + \\ ∇ {p}_{s} ( x , y , z , t ) \cdot ∇ {p}_{r} ( x , y , z , T - t ) dt\end{matrix}}{{\sum }_{s} {\int }_{0}^{T} {p}_{s}^{2} ( x , y , z , t ) dt} \qquad [ Equation l ]$$

Here, in Equation 2, I_{ISIC} is the migration image value under the inverse scattering imaging condition, Σs and Σr are the summation processes for all sources and all receivers, respectively, T is the total recording time, pₛ is the source wavefield obtained by forward propagation at the source location, pᵣ is the receiver wavefield obtained by back-propagating a virtual source at the receiver location, vₚ is the P-wave velocity at each (x, y, z) location, and ∇ is a spatial gradient.

In the reverse-time migration of streamer survey data, relatively satisfactory migration images can be expected just by utilizing the inverse scattering imaging condition described above, however, in the VCS survey, since reflection signals with larger reflection angles than the streamer survey are recorded even at the same offset due to the receivers located deep in the survey design, and these signals cause strong long-wavelength artifacts in the reverse-time migration of VCS survey data, the reflection boundary in the migration images is screened by the long-wavelength artifacts, resulting in image quality degradation despite the inverse scattering imaging condition being utilized.

Therefore, to solve the above problems, the conventional reverse-time migration of VCS survey data utilized a method in which, rather than using pressure wavefields observed during back-propagation of receiver wavefields as virtual sources, primary reflections propagating upward and having a large range of reflection angles are removed through the up/down wavefield separation process and only receiver ghosts propagating downward and guaranteeing relatively narrow reflection angles are extracted and utilized as virtual sources of the receiver wavefields.

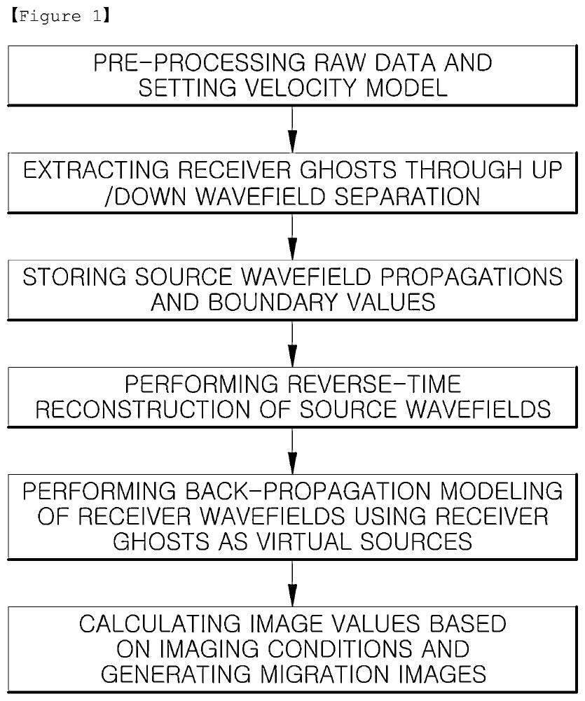

Reference is now made to FIG. 1 which is a flowchart schematically illustrating the overall configuration of a conventional reverse-time migration method for VCS survey data, utilizing only receiver ghosts.

As shown in FIG. 1, the conventional reverse-time migration method includes pre-processing the observed VCS pressure wavefield data and setting a velocity model, extracting receiver ghosts through the up/down wavefield separation, storing source wavefield propagations and boundary values at all time steps and performing the reverse-time reconstruction of source wavefields, modeling back-propagation of receiver wavefields using receiver ghosts as virtual sources, and calculating image values for each time step and all source-receiver pairs based on the inverse scattering imaging condition as shown in Equation 2 to generate reverse-time migration images.

Here, since the more specific details of the reverse-time migration method illustrated in FIG. 1 are obvious to those skilled in the art by referring to the contents of the reverse-time migration method of the conventional technique, it should be noted that, in the present disclosure, the detailed description of parts which are obvious to those skilled in the art from the contents of the prior art as described above, or which can be easily understood and practiced by those skilled in the art by referring to the literature of the prior art will be omitted for the sake of simplicity of description.

In other words, since receiver ghosts guarantee relatively narrow reflection angles compared to primary reflections, the conventional reverse-time migration of VCS survey data utilizing only the receiver ghosts can effectively suppress long-wavelength artifacts.

However, since the conventional reverse-time migration of VCS survey data utilizing only the receiver ghosts performs reverse-time migration after removing all the primary reflections having the strongest amplitude among the recorded reflection signals regardless of the magnitude of the reflection angle, the primary reflection signals with narrow reflection angles that are useful for constructing the reflection boundary cannot be utilized, and the migration image value in the reflection boundary will become weaker, and as a result, the cross-correlation image noise between reflections generated from different reflection points or between multiple reflections and reflections is relatively emphasized, resulting in a decrease in the quality of the generated migration images.

An additional image noise generated during reverse-time migration also causes a decrease in the quality of the generated migration images since perfect wavefield separation is not possible no matter which up/down wavefield separation method is used, for example, frequency-wavenumber filters, radon transform filters, median filters, singular value decomposition filters, or the like.

In addition, in the case of a median filter, which is popularly utilized for up/down wavefield separation, a wavefield flattening process is required, so the conventional reverse-time migration method utilizing only receiver ghosts complicates the overall migration process.

In view of the above, unlike the conventional technique, which solved the problem of the reflection boundary screening by long-wavelength artifacts utilizing the receiver ghosts extracted by performing up/down wavefield separation on the observed pressure wavefields as virtual sources, the present disclosure proposes a reverse-time migration method for vertical cable seismic (VCS) survey data using directional propagation of receiver wavefields, which is configured to solve the problem of the reflection boundary screening by long-wavelength artifacts by performing equation-of-motion-based transform and inverse-transform processing on the observed pressure wavefields and utilizing them as virtual sources of the receiver wavefields.

More specifically, assuming the density of seawater being 1, the Newton's equation of motion can be expressed as Equation 3, which represents the relationship between a pressure wavefield and a particle acceleration wavefield.

$$a ( x , y , z , t ) = ∇ p ( x , y , z , t ) \qquad [ Equation 3 ]$$

Here, in Equation 3, p is a pressure wavefield at a certain position expressed by (x, y, z) and time t, a=(αx, αy, αz) is a component vector of a particle acceleration wavefield, and ∇ is a spatial gradient.

In other words, Equation 3 indicates that the particle acceleration wavefield for each direction can be calculated through the spatial finite difference of the pressure wavefields, and when this transform process is expressed by a linear operator Q, the process of inverse-transforming the calculated particle acceleration wavefield into the form of pressure wavefield data is defined as the transpose (Q^{T}) of the linear operator Q, and the process of sequentially performing the corresponding transform and inverse-transform can be expressed mathematically as Equation 4.

$${p}^{′} = {Q}^{T} Qp \qquad [ Equation 4 ]$$

Here, in Equation 4, p is a vector composed of the pressure wavefield data observed at the locations of a certain group of receivers located in the vicinity, and p′ is a vector composed of the pressure wavefield data processed through the transform and inverse-transform processes at the same receiver locations.

In Equation 4, the vector composed of the pressure wavefields observed at a certain group of receivers does not have directional information regarding the direction in which acoustic waves were incident on the receiver; however, the directional information of the recorded acoustic waves is extracted through the process (Q) of transform into the particle acceleration wavefield data, and the directional information is preserved even after the process (Q^{T}) of inverse-transform into the form of pressure wavefields.

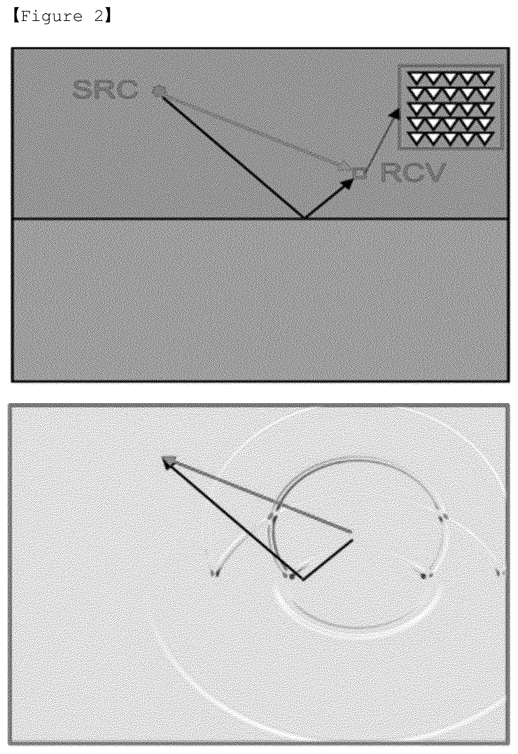

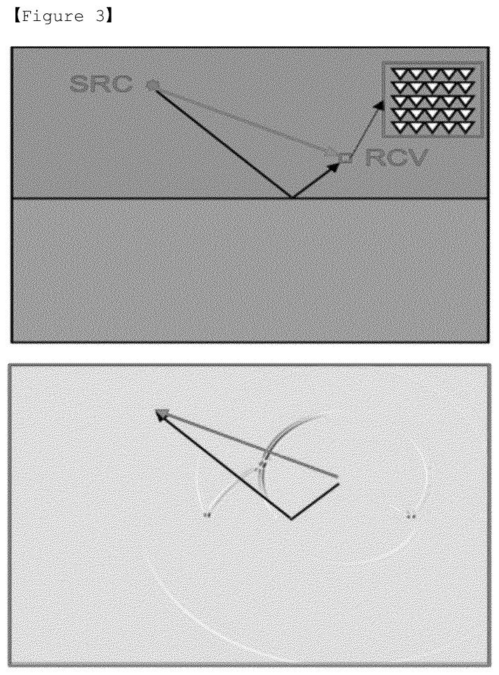

Reference is now made to FIGS. 2 and 3, which are diagrams illustrating isotropic propagation (FIG. 2) of receiver wavefields when twenty-five receivers are arranged in a grid and the observed pressure wavefield data is utilized directly as virtual sources and directional propagation (FIG. 3) of receiver wavefields when pressure wavefield data having undergone transform and inverse-transform proposed in the present disclosure is utilized as virtual sources, respectively.

As can be understood from FIGS. 2 and 3, when the observed pressure wavefield data is utilized directly as virtual sources, the receiver wavefields propagate isotropically in all directions regardless of the ray path along which the direct waves and reflections arrive at the receiver, whereas, when the pressure wavefield data processed through the transform and inverse-transform processes is utilized as virtual sources, the wave propagation energy concentrates along the ray paths that the direct waves and reflections have traveled, and the waves propagate in a directional manner.

In particular, when the receiver wavefield directional propagation method described above is applied to the reverse-time migration of VCS survey data, due to the vertical receiver array of the VCS survey, the wavefield components with a large horizontal component in the ray path from the source to the receiver, such as reflections with wide reflection angles, are weakened, and the wavefield components with a large vertical component in the ray path, such as reflections with narrow reflection angles, are strengthened, which has the effect of suppressing long-wavelength artifacts when generating migration images.

According to the present disclosure, the problem of the reflection boundary screening by strong long-wavelength artifacts in the reverse-time migration of VCS survey data without up/down wavefield separation can be solved, and therefore, the overall quality of the generated migration images can be improved by utilizing the primary reflection signals with narrow reflection angles and blocking additional image noise.

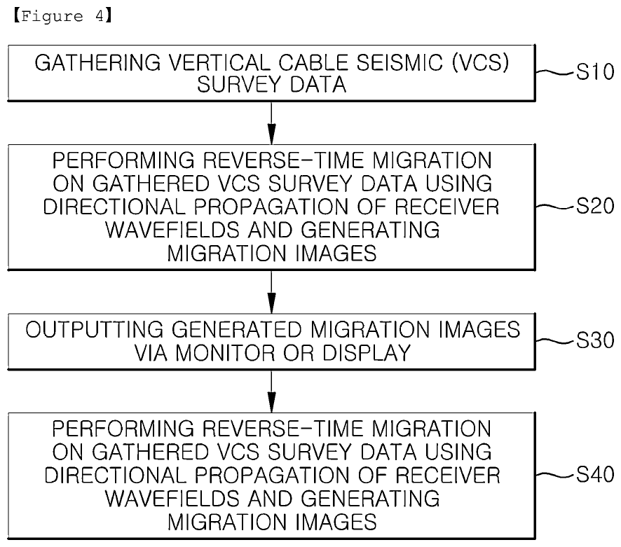

More specifically, reference is now made to FIG. 4, which is a flowchart schematically illustrating the overall configuration of a reverse-time migration method for vertical cable seismic (VCS) survey data utilizing directional propagation of receiver wavefields according to the embodiment of the present disclosure.

As shown in FIG. 4, the reverse-time migration method of VCS survey data using directional propagation of receiver wavefields according to the embodiment of the present disclosure includes a data gathering step (S10) in which a process of gathering vertical cable seismic (VCS) survey data is performed, a reverse-time migration processing step (S20) in which a process of performing a reverse-time migration process using directional propagation of receiver wavefields as described later on the VCS survey data gathered through the data gathering step (S10) to generate migration images is performed, an image output step (S30) in which a process of outputting the migration images generated through the reverse-time migration processing step (S20) via a monitor, a display, or the like is performed, and a database construction step (S40) in which a process of constructing a database by storing various pieces of data obtained through the processing of each of the above steps and the processing results in a separate database or transmitting them to an external device such as a server according to a predetermined setting is performed.

Here, the data gathering step (S10) may be configured so that a process of receiving real-time survey data from a vertical cable seismic (VCS) survey means installed in a survey area, or receiving input of survey data gathered in advance from an external source is performed.

Furthermore, the reverse-time migration processing step (S20) is configured to solve the problem of the reflection boundary screening by long-wavelength artifacts in the migration images by transforming the observed pressure wavefield data into particle acceleration wavefield data, inverse-transforming the particle acceleration wavefield data into the form of pressure wavefields, and enabling directional propagation of the receiver wavefields utilizing the pressure wavefields as virtual sources during back-propagation of the receiver wavefields.

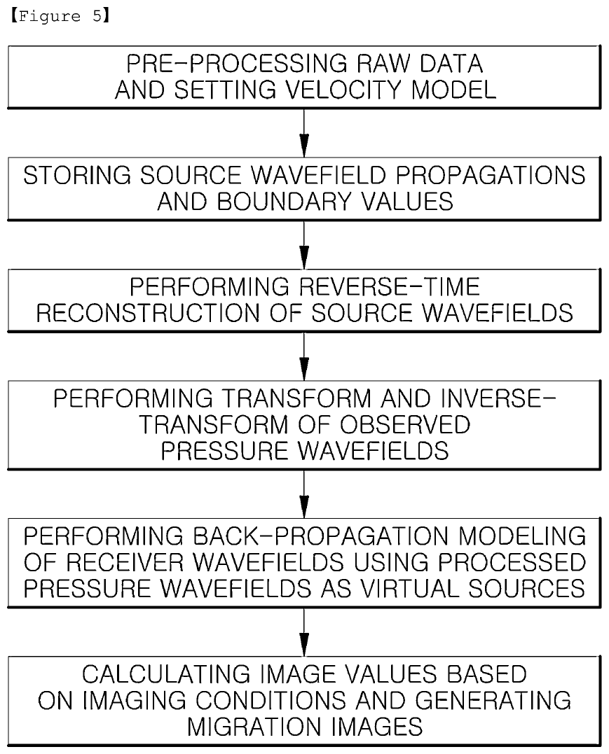

More specifically, reference is now made to FIG. 5, which is a flowchart schematically illustrating the overall processing of the reverse-time migration processing step (S20) in the reverse-time migration method for vertical cable seismic (VCS) survey data using directional propagation of receiver wavefields according to the embodiment of the present disclosure shown in FIG. 4.

As shown in FIG. 5, the reverse-time migration processing step (S20) includes a processing step of performing predetermined pre-processing on the observed VCS pressure wavefield data and determining a velocity model, a processing step of storing source wavefield propagations and boundary values at all time steps and performing the reverse-time reconstruction of source wavefields, and an image generation step of calculating image values for each time step and all source-receiver pairs based on the inverse scattering imaging condition as shown in Equation 2 to generate reverse-time migration images, and in this respect, the reverse-time migration processing step (S20) can be configured in the same or similar manner as the conventional reverse-time migration method.

However, the reverse-time migration step (S20) according to an embodiment of the present disclosure is different from the conventional VCS survey data reverse-time migration method; that is, as shown in FIG. 5, instead of the processing step of extracting receiver ghosts from the observed pressure wavefields through up/down wavefield separation and the processing step of modeling back-propagation of receiver wavefields using the extracted receiver ghosts as virtual sources, the reverse-time migration processing step (S20) includes a transform and inverse-transform processing step in which a process of transforming the observed pressure wavefield data into particle acceleration wavefield data and then inverse-transforming the particle acceleration wavefield data into the form of pressure wavefield data is performed and a back-propagation modeling processing step in which a process of modeling back-propagation of receiver wavefields using the observed pressure wavefield data having undergone the transform and inverse-transform processing as virtual sources.

Here, the specific details of the processing step of transforming the pressure wavefield data into particle acceleration wavefield data as described above and performing the inverse-transform back into the form of pressure wavefields to perform directional propagation of the receiver wavefields can be configured as described above with reference to Equation 3 and Equation 4, and the remaining portions may be configured in the same or similar manner as the conventional reverse-time migration method; therefore, the redundant description of parts that are obvious to those skilled in the art from the contents of the conventional technique will be omitted for the sake of simplicity of description.

Thus, with the configuration described above, it is possible to suppress long-wavelength artifacts that appear in the reverse-time migration of VCS survey data, and improve the overall quality of migration images by utilizing primary reflection signals with narrow reflection angles and blocking additional image noises compared to the conventional method that utilizes only receiver ghosts.

Furthermore, unlike the conventional method, the up/down wavefield separation process is eliminated, which simplifies the overall reverse-time migration process and facilitates parallel processing utilizing multi-processors, thereby reducing computational costs.

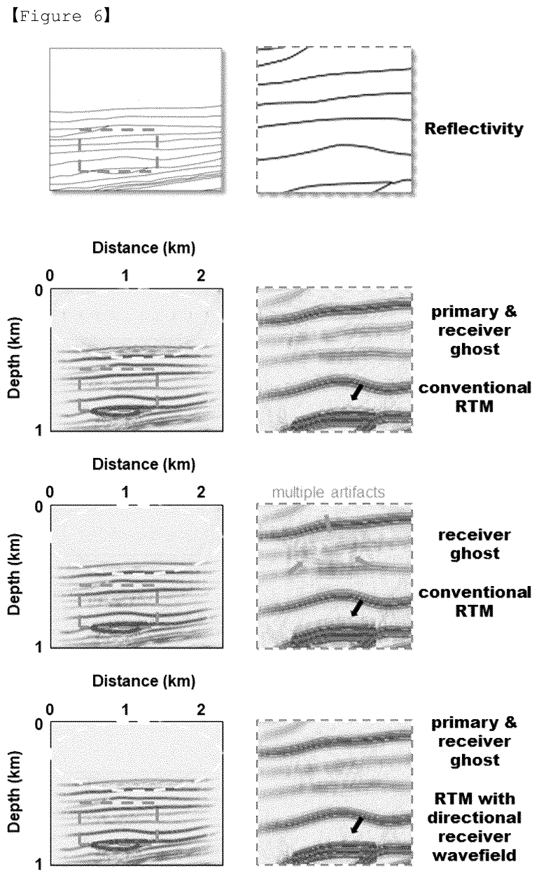

Next, reference is now made to FIG. 6, which is a diagram illustrating a comparison of migration images generated by applying conventional VCS survey data reverse-time migration techniques and migration images generated by applying the technique of the present disclosure to verify the actual performance of the reverse-time migration method for vertical cable seismic (VCS) survey data using directional propagation of receiver wavefields according to the embodiment of the present disclosure.

More specifically, FIG. 6 is a diagram illustrating the results of the imaging test of the reverse-time migration method of VCS survey data according to the embodiment of the present disclosure using some of the Marmousi models that are widely utilized in the development and testing process in the field of seismic data processing; in this test, smoothing is applied to the actual velocity model and the smoothed velocity model is utilized as the velocity values in the reverse-time migration, and in all cases, the reverse-time migration is performed based on the inverse scattering imaging condition.

As can be understood from FIG. 6, when the directional propagation of the receiver wavefields is utilized according to the reverse-time migration method of the embodiment of the present disclosure, the long-wavelength artifacts at the upper end are suppressed to a level similar to that of the conventional technique utilizing receiver ghosts alone, and the overall level of image noise in the migration images is lowered and the reflection layer in the reflectivity model is more clearly shown as compared to the conventional technique utilizing only receiver ghosts, and therefore, the quality of the migration images generated by the reverse-time migration can be improved.

In this way, the reverse-time migration method of vertical cable seismic (VCS) survey data using directional propagation of receiver wavefields according to the embodiment of the present disclosure can be implemented, and using the method, a reverse-time migration apparatus and a VCS imaging system of vertical cable seismic (VCS) survey data using directional propagation of receiver wavefields can be easily implemented.

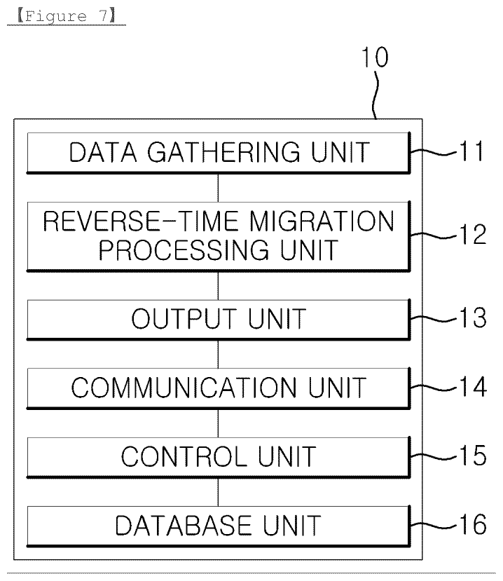

Reference is now made to FIG. 7, which is a block diagram schematically illustrating the overall configuration of a VCS survey data reverse-time migration apparatus 10 configured using the reverse-time migration method for vertical cable seismic (VCS) survey data using directional propagation of receiver wavefields according to the embodiment of the present disclosure configured as described above.

As shown in FIG. 7, the VCS survey data reverse-time migration apparatus 10 according to the embodiment of the present disclosure includes a data gathering unit 11 configured to perform a process of gathering VCS survey data, a reverse-time migration processing unit 12 configured to perform a process of performing reverse-time migration on the VCS survey data gathered by the data gathering unit 11, an output unit 13 configured to perform a process of visually displaying various pieces of data including the data gathered by the data gathering unit 11, the processing results from the reverse-time migration processing unit 12, and information on the current state and operation of the reverse-time migration apparatus 10 via a monitor, a display, or the like according to a predetermined setting, a communication unit 14 configured to perform a process of transmitting and receiving various pieces of data by communicating with an external device such as a server in at least one of wired or wireless communication according to a predetermined setting, and a control unit 15 configured to perform a process of controlling the overall operation of the above-mentioned units and the reverse-time migration apparatus 10. The reverse-time migration apparatus 10 may include one or more processors and one or more memory modules, and the one or more memory modules. The data gathering unit 11, the reverse-time migration processing unit 12, the output unit 13, the communication unit 14, and the control unit 15 may be program modules in the form of operating systems, application program modules, and other program modules stored in the memory modules. Such program modules may include, but are not limited to, routines, subroutines, programs, objects, components, and data structures for performing specific tasks or executing specific abstract data types according to the invention as will be described below.

Here, the reverse-time migration processing unit 12 may be configured to perform a reverse-time migration process on the vertical cable seismic (VCS) survey data using the reverse-time migration method for the VCS survey data using directional propagation of receiver wavefields according to the embodiment of the present disclosure configured as described above, and in this way, the quality of the reverse-time migration images can be improved with a simpler configuration compared to the conventional reverse-time migration processing apparatus and method.

Furthermore, the data gathering unit 11 may be configured to perform a process of receiving real-time survey data from a separate vertical cable seismic (VCS) survey means or receiving input of survey data gathered in advance.

Further, as shown in FIG. 7, the reverse-time migration apparatus 10 may further include a database unit 16 for storing various pieces of information obtained in the reverse-time migration process of the vertical cable seismic (VCS) survey data.

In this case, the control unit 15 may be configured to perform, based on the data stored in the database unit 16, a process of providing various pieces of information obtained through the reverse-time migration of the vertical cable seismic (VCS) survey according to the request of the user in conjunction with an external device such as, for example, a user terminal or a server in a customized manner, and in this way, a VCS imaging system capable of providing various pieces of information related to the VCS survey for each area in addition to the VCS survey data can be easily implemented.

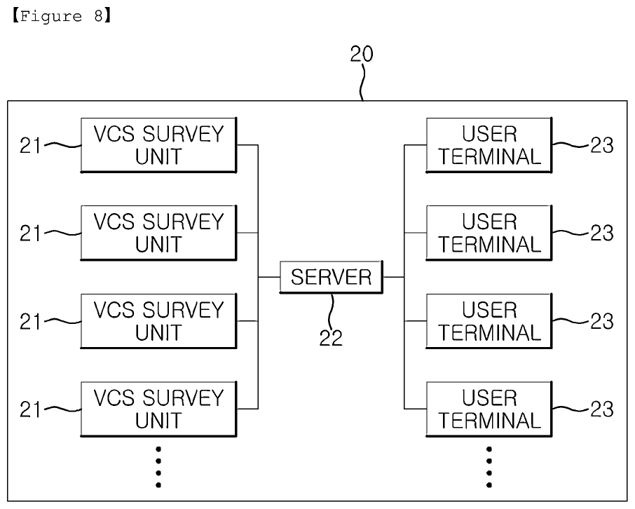

Reference is now made to FIG. 8, which is a block diagram schematically illustrating the overall configuration of a vertical cable seismic (VCS) imaging system 20 according to an embodiment of the present disclosure.

As shown in FIG. 8, the VCS imaging system 20 according to an embodiment of the present disclosure includes a plurality of VCS survey units 21 configured to perform a process of gathering vertical cable seismic (VCS) survey data for each area and performing reverse-time migration to generate VCS migration images, a server 22 configured to perform a process of storing the survey information gathered by the VCS survey units 21 and the migration images for each area in a database and providing a corresponding service according to the request of the user, and a user terminal 23 for requesting and receiving a service desired by each user in connection with the VCS survey units 21 and the server 22.

Here, as with the reverse-time migration apparatus 10 according to the embodiment of the present disclosure shown in FIG. 7, the VCS survey unit 21 may be configured to perform a process of performing a reverse-time migration process on the VCS survey data and transmitting the gathered survey data and the processed data to a server using the reverse-time migration method for the vertical cable seismic (VCS) survey data using directional propagation of receiver wavefields according to the embodiment of the present disclosure configured as described above.

Furthermore, the user terminal 23 may be configured as dedicated hardware interfacing with the VCS survey units 21 and the server 22, or preferably, may be configured by installing a dedicated application on a personal portable telecommunication terminal such as, for example, a smartphone or a tablet PC, or an information processing device such as a PC or a laptop; however, it should be noted that the present disclosure is not necessarily limited to such a configuration, that is, the present disclosure may be configured in various modifications and changes as necessary by those skilled in the art without departing from the spirit and gist of the present disclosure.

Accordingly, as described above, it is possible to easily implement the reverse-time migration method for the vertical cable seismic (VCS) survey data using directional propagation of receiver wavefields according to the embodiment of the present disclosure, and the reverse-time migration apparatus and the VCS imaging system using the same, and as a result, it is possible to solve the problem of the reflection boundary screening due to long-wavelength artifacts in the reverse-time migration of VCS survey data, and avoid the up/down wavefield separation, thereby improving the quality of reverse-time migration images with a simpler configuration than the conventional reverse-time migration apparatus and method.

Through the above-described embodiments of the present disclosure, the specific details of the reverse-time migration method for vertical cable seismic (VCS) survey data using directional propagation of receiver wavefields according to the present disclosure have been described; however, since the present disclosure is not limited to the contents described in the above-described embodiments, it is to be understood that the present disclosure can be modified, changed, combined, and substituted in various ways according to design needs and various other factors by those of ordinary skill in the technical field to which the present disclosure belongs.

### DESCRIPTION OF REFERENCE NUMERALS AND SYMBOLS

10: Vertical cable seismic (VCS) survey data reverse-time migration apparatus
11: Data survey unit
12: Reverse-time migration processing unit
13: Output unit
14: Communication unit
15: Control unit
16: Database unit
20: Vertical cable seismic (VCS) imaging system
21: VCS survey unit
22: Server
23: User terminal

What is claimed is:

1. A reverse-time migration method for vertical cable seismic (VCS) survey data using directional propagation of receiver wavefields, the method comprising:
a data gathering step in which a process of gathering vertical cable seismic (VCS) survey data is performed; and
a reverse-time migration processing step in which a process of performing reverse-time migration based on directional propagation of receiver wavefields on the VCS survey data gathered through the data gathering step to generate migration images is performed.

2. The reverse-time migration method for vertical cable seismic (VCS) survey data using directional propagation of receiver wavefields according to claim 1, the method further comprising:
an image output step in which a process of outputting the migration images generated through the reverse-time migration processing step via a monitor or a display is performed; and
a database construction step in which a process of constructing a database by storing various pieces of data obtained through the processes and processing results of the data gathering step and the reverse-time migration processing step in a separate database or transmitting the data to an external device according to a predetermined setting is performed.

3. The reverse-time migration method for vertical cable seismic (VCS) survey data using directional propagation of receiver wavefields according to claim 1, wherein the data gathering step is configured so that a process of receiving real-time survey data from a vertical cable seismic (VCS) survey means installed in a survey area or receiving input of survey data gathered in advance from an external source is performed.

4. The reverse-time migration method for vertical cable seismic (VCS) survey data using directional propagation of receiver wavefields according to claim 1, wherein the reverse-time migration processing step comprises:
a pre-processing step in which a process of performing pre-processing on observed VCS pressure wavefield data according to a predetermined setting and determining a velocity model is performed;
a reverse-time reconstruction processing step in which a process of modeling source wavefield propagation, storing boundary values at all time steps, and performing reverse-time reconstruction of source wavefields is performed;
a transform and inverse-transform processing step in which a process of transforming the observed pressure wavefield data into particle acceleration wavefield data and then performing inverse-transform is performed;
a back-propagation modeling processing step in which a process of performing back-propagation modeling of receiver wavefields using the observed pressure wavefield data having undergone the transform and inverse-transform processing as virtual sources is performed; and
an image generation step in which a process of combining processing results from the reverse-time reconstruction processing step and the back-propagation modeling processing step into a predetermined inverse scattering imaging condition to calculate image values for each time step and all source-receiver pairs is performed.

5. The reverse-time migration method for vertical cable seismic (VCS) survey data using directional propagation of receiver wavefields according to claim 4, wherein the transform and inverse-transform processing step is configured so that a transform process of transforming the observed pressure wavefield data into particle acceleration wavefield data is performed by calculating a particle acceleration wavefield for each direction through a spatial finite difference of pressure wavefields based on a relational expression between a pressure wavefield and a particle acceleration wavefield, and
the relational expression is represented by the following equation:
a(x,y,z,t)=∇p(x,y,z,t)
where p is a pressure wavefield at a certain position expressed by (x, y, z) and time t, a=(αx, αy, αz) is a component vector of a particle acceleration wavefield, and ∇ is a spatial gradient.

6. The reverse-time migration method for vertical cable seismic (VCS) survey data using directional propagation of receiver wavefields according to claim 5, wherein the transform and inverse-transform processing step is configured so that, based on a fact that, when a transform process of transforming the observed pressure wavefield data into particle acceleration wavefield data is represented by a linear operator Q, the inverse-transform process of inverse-transforming the transformed particle acceleration wavefields back to pressure wavefields is defined as Q^{T} a transpose of the linear operator Q, the transform process and the inverse-transform process are sequentially performed using the following equation:
p′=Q^{T}Qp
where p is a vector composed of the pressure wavefield data observed at a location of a group of receivers, and p′ is a vector composed of pressure wavefield data calculated at the same location through the transform and inverse-transform processes.

7. The reverse-time migration method for vertical cable seismic (VCS) survey data using directional propagation of receiver wavefields according to claim 4, wherein the reverse-time migration processing step is configured so that the reverse-time reconstruction processing step, the transform and inverse-transform processing step, and the back-propagation modeling processing step are processed in parallel for each source using multi-processors.

8. The reverse-time migration method for vertical cable seismic (VCS) survey data using directional propagation of receiver wavefields according to claim 4, wherein the image generation step is configured so that a process of generating reverse-time migration images using an inverse scattering imaging condition (ISIC) expressed by the following equation is performed:
$${I}_{ISIC} ( x , y , z ) = \frac{\begin{matrix}{\sum }_{s} {\sum }_{r} {\int }_{0}^{T} \frac{1}{{v}_{p}^{2} ( x , y , z )} \frac{\partial {p}_{s} ( x , y , z , t )}{\partial t} \times \frac{\partial {p}_{r} ( x , y , z , T - t )}{\partial t} + \\ ∇ {p}_{s} ( x , y , z , t ) \cdot ∇ {p}_{r} ( x , y , z , T - t ) dt\end{matrix}}{{\sum }_{s} {\int }_{0}^{T} {p}_{s}^{2} ( x , y , z , t ) dt} ,$$
where I_{ISIC} is a migration image value under the inverse scattering imaging condition, Σs and Σr are summation processes for all sources and all receivers, respectively, T is a total recording time, pₛ is a source wavefield obtained by forward propagation at a source location, pᵣ is a receiver wavefield obtained by back-propagating a virtual source at a receiver location, vₚ is a P-wave velocity value at each (x, y, z) location, and ∇ is a spatial gradient.

9. A reverse-time migration apparatus for vertical cable seismic (VCS) survey data, comprising:
a data gathering unit configured to perform a process of gathering vertical cable seismic (VCS) survey data;
a reverse-time migration processing unit configured to perform a process of performing reverse-time migration on the VCS survey data gathered by a data survey unit;
an output unit configured to perform a process of outputting various pieces of data including data gathered by the data gathering unit, processing results from the reverse-time migration processing unit, and information on a current state and an operation of the reverse-time migration apparatus;
a communication unit configured to perform a process of transmitting and receiving various pieces of data by communicating with an external device including a server in at least one of wired or wireless communication according to a predetermined setting; and
a control unit configured to perform a process of controlling an overall operation of the reverse-time migration apparatus,
wherein the reverse-time migration processing unit is configured to perform a reverse-time migration process using the reverse-time migration method for vertical cable seismic (VCS) survey data using directional propagation of receiver wavefields according to claim 1.

10. The reverse-time migration apparatus for vertical cable seismic (VCS) survey data according to claim 9, wherein the data gathering unit is configured to perform a process of receiving real-time survey data from a separate vertical cable seismic (VCS) survey means or receiving input of survey data gathered in advance.

11. The reverse-time migration apparatus for vertical cable seismic (VCS) survey data according to claim 9, wherein the output unit is configured to include a monitor or a display for visually displaying the various pieces of data including the data gathered by the data gathering unit, the processing results from the reverse-time migration processing unit, and the information on the current state and the operation of the reverse-time migration apparatus according to a predetermined setting.

12. The reverse-time migration apparatus for vertical cable seismic (VCS) survey data according to claim 9, further comprising:
a database unit for storing various pieces of data obtained through the processing of the data gathering unit and the reverse-time migration processing unit,
wherein the control unit is configured to perform, based on the data stored in the database unit, a process of providing various pieces of information obtained through a vertical cable seismic (VCS) survey according to a request of a user in conjunction with an external device including a user terminal and a server in a customized manner.

13. A vertical cable seismic (VCS) imaging system, comprising:
a plurality of VCS survey units configured to perform a process of gathering vertical cable seismic (VCS) survey data for each area and performing reverse-time migration to generate VCS migration images;
a server configured to perform a process of storing survey information gathered by the VCS survey units and the migration images for each area in a database and providing a corresponding service according to a request of a user; and
a user terminal for requesting and receiving a service desired by each user in connection with the VCS survey units and the server,
wherein the VCS survey unit is configured to perform a process of performing a reverse-time migration process on the VCS survey data using the reverse-time migration method for vertical cable seismic (VCS) survey data using directional propagation of receiver wavefields according to claim 1 and transmitting the gathered survey data and the processed data to the server.

14. The vertical cable seismic (VCS) imaging system according to claim 13, wherein the user terminal is configured by installing a dedicated application interfacing with the VCS survey units and the server on a personal portable telecommunication terminal including a smartphone and a tablet PC, or an information processing device including a PC and a laptop.
